(19) United States
(12) Patent Application Publication
(10) Pub. No.: US 2024/0193210 A1
(43) Pub. Date: Jun. 13, 2024

(54) COMPUTER-IMPLEMENTED METHOD, COMPUTER PROGRAM AND DEVICE FOR EXTENDING A GRAPH

(71) Applicant: Robert Bosch GmbH, Stuttgart (DE)

(72) Inventor: Henrik Dibowski, Bad Liebenzell (DE)

(21) Appl. No.: 18/554,281

(22) PCT Filed: Jun. 24, 2022
(86) PCT No.: PCT/EP2022/067399

§ 371 Date: Oct. 6, 2023

(30) Foreign Application Priority Data
Jul. 5, 2021 (EP) 21183642.4

(51) Int. Cl. G06F 16/903; G06F 16/901; G06F 16/9038

(52) U.S. Cl. CPC G06F 16/90335; G06F 16/9024; G06F 16/9038

(57) ABSTRACT

Device, computer program, computer-implemented method for extending a graph, in particular a knowledge graph. The method includes: predefining an input variable comprising an instance to be extended and a relation associated with the instance to be extended and/or an attribute of the graph related to the instance to be extended, determining a first property assertion constraint associated with the input variable, determining a query fragment for the first property assertion constraint, determining a query including a predefined core query and the query fragment, executing the query on the graph. A first result is determined that includes either at least one permissible instance and/or at least one permissible literal for extending the graph database or no instance and no literal.

### FIELD

The present invention relates to a computer-implemented method, a computer program and a device for, in particular, informed, well-founded and/or error-avoiding extension of a graph, in particular a knowledge graph, which is semantically as correct as possible.

### BACKGROUND INFORMATION

The detection of errors in already invalid graphs can take place, for example, by means of suitable languages. For knowledge graphs, this can take place, for example, by means of Web Ontology Language (OWL), based reasoning or Shapes Constraint Language (SHACL), or Shape Expressions (ShEx).

The W3C recommendation of 11 Dec. 2012, retrievable from https://www.w3.org/TR/ow12-overview/, describes aspects of OWL.

The W3C recommendation of 20 Jul. 2017, retrievable from https://www.w3.org/TR/shacl/, describes aspects of SHACL.

https://shex.io/describes aspects of ShEx.

In graphs, in particular knowledge graphs, errors can be detected by graph exploration. In graph exploration, alternative paths are sought that can be used to confirm or disprove a relation between two entities. Due to their statistical or probabilistic nature and/or use of heuristics, false facts can also be overlooked, or facts that are correct can be detected as false.

Errors in graphs can be detected by approaches that access external information such as Wikipedia, Wikidata, web pages, texts, etc., in order, for example, to obtain indications for the correctness or incorrectness of modeled knowledge by natural language processing.

The following papers describe such procedures
H. Paulheim: “Knowledge Graph Refinement: A Survey of Approaches and Evaluation Methods”, Semantic Web 0 (2015) 1-0, http://semantic-web-journal.net/system/files/swj1167.pdf
E. Huaman, E. Kärle, D. Fensel: “Knowledge Graph Validation”, 2020, https://arxiv.org/abs/2005.01389
Melo, H. Paulheim: “Detection of Relation Assertion Errors in Knowledge Graphs”, Knowledge Capture Conference, 2017, https://dl.acm.org/doi/abs/10.1145/3148011.3148033

### SUMMARY

Errors in a graph, in particular in a knowledge graph, may be avoided with the computer-implemented method, the computer program and the device according to features of the present invention. Errors are, for example, semantically incorrect facts that infringe the laws, rules, constraints, etc. that prevail in a domain. Validity of the knowledge contained is improved.

According to an example embodiment of the present invention, a computer-implemented method for extending a graph, in particular a knowledge graph, comprises predefining an input variable comprising an instance to be extended and a relation associated with the instance to be extended and/or an attribute of the graph related to the instance to be extended; determining a first property assertion constraint associated with the input variable; determining a query fragment for the first property assertion constraint; determining a query comprising a predefined core query and the query fragment; executing the query on the graph, a result being determined that comprises either at least one permissible instance and/or at least one permissible literal for extending the graph or no instance and no literal. The query also comprises the query fragment. In the example, the instances or literals permissible for the predefined instance are ascertained by means of the query, taking into account the condition defined in the property assertion constraint. It is possible that the query itself provides no instance and no literal, because, in particular due to incomplete facts, for example, certain preconditions for the property assertion constraint in the graph are not yet defined, or because no instance that completely fulfills the property assertion constraint exists until now.

According to an example embodiment of the present invention, preferably, the method provides for the first result to be displayed to a user or output to a machine. As a result, the information for selecting the extension, which also leads to an error-free extension, is made accessible to the user via an in particular graphical user interface or to the machine via a machine-machine interface.

According to an example embodiment of the present invention, preferably, a second property assertion constraint is determined, wherein for the second property assertion constraint a second result is determined that either comprises at least one permissible instance and/or at least one permissible literal for the extension of the graph or no instance and no literal, wherein a sequence of inputs of the user or inputs from the machine is requested depending on the first result and the second result, and the graph is extended depending on the sequence, wherein the sequence defines an order for queries of the inputs in which a first query is made according to the first result before a second query is made according to the second result, wherein the second result or the second query is determined depending on an input in response to the first query. In particular, multiple extensions are carried out step by step by property assertion constraints. A property assertion constraint that follows a different property assertion constraint operates on a changed graph, as a result of which logical dependencies are taken into account. As a result, complex, mutually dependent conditions are resolved and taken into account step by step.

According to an example embodiment of the present invention, preferably, in the method, a selection of at least one permissible instance for the extension of the graph is detected, and the graph is extended by a predefined relation of the instance to be extended to this instance, and/or a selection of at least one permissible literal for the extension of the graph is detected, and the graph is extended by an attribute for the instance to be extended. Inconsistent extensions are thereby avoided.

According to an example embodiment of the present invention, the determination of the first property assertion constraint preferably comprises determining the property assertion constraint assigned to the instance to be extended or assigned to a class assigned to the instance to be extended.

In the context of the present description, a property comprises a relation and/or an attribute. In the context of the present description, a class comprises one or more instances. A property assertion constraint can be provided for each class-property pair. Property assertion constraints do not have to be defined for all the properties of each class. There can also be classes that do not have direct instances. Superclasses are often declared abstract. These do not comprise instances themselves, only indirectly via one of their subclasses. Preferably, a property assertion constraint is defined where such a property assertion constraint exists in a domain about which the graph contains knowledge. If no property assertion constraint is defined, a value range of the property can be used to determine a permissible instance or a permissible literal.

A class can have superclasses. For one or more superclasses, it is also possible to define property assertion constraints for the properties thereof in each case. Then multiple class-specific property assertion constraints are available for selection, from which the property assertion constraint that is closest to the class of the instance in the class hierarchy is selected, ideally the property assertion constraint of the direct class of the instance, if present. For example, the instance to be extended is assigned to a first class. In the example, the first class is a direct class of the instance to be extended. Determining the property assertion constraint preferably comprises determining the property assertion constraint assigned to a second class that is closest to the first class in a class hierarchy. The closest or lowest in the class hierarchy means, for example, closest to the direct class of the instance to be extended in the knowledge graph according to a distance measure. If a property assertion constraint is defined for the direct class of the instance, this can then be used. Otherwise the superclass hierarchy of the direct class can be searched and the existence of property assertion constraints for the given property can be checked. If there is exactly one such property assertion constraint, then this is used. If there are multiple property assertion constraints, then the correct property assertion constraint is the one whose class is closest class to the direct class. This has, for example, the smallest number of hierarchy levels in a chain of rdfs: subClassOf relations, and is therefore most similar in the semantic sense.

According to an example embodiment of the present invention, determining the property assertion constraint preferably comprises finding a constraint in the graph database that applies to the instance. An instance-specific property assertion constraint in the graph database itself is determined thereby.

According to an example embodiment of the present invention, it is preferably provided that, if it is detected that no relevant property assertion constraint exists, the query is determined without a query fragment. As a result, an extension is also made possible in this case.

According to an example embodiment of the present invention, the input variable can be read from a graph database in which the graph is stored, in particular from a memory for triples of the knowledge graph, wherein the query is executed on the graph database. Optionally, the result for the extension of the graph can be stored in the graph database.

According to an example embodiment of the present invention, the device for extending a graph, in particular a knowledge graph, is designed to carry out the method.

According to an example embodiment of the present invention, the computer program comprises computer-readable instructions, during the execution of which by a computer the method proceeds.

Further advantageous embodiments of the present invention can be found in the description below and in the figures.

### BRIEF DESCRIPTION OF THE DRAWINGS

FIG. 1 shows a schematic representation of a device for extending a graph, according to an example embodiment of the present invention.

FIG. 2 shows a flowchart of a method for extending a graph, according to an example embodiment of the present invention.

### DETAILED DESCRIPTION OF EXAMPLE EMBODIMENTS

In the following description, restrictions of properties are used for a well-founded and/or error-avoiding extension of a graph that is as semantically correct as possible. This is described below for a knowledge graph using the example of a Resource Description Framework graph (RDF graph), which is evaluated, for example, with OWL or SHACL.

The knowledge graph can be an RDF graph. The knowledge graph can be extended with OWL. In the example, RDFS is used. RDFS is an extension of RDF, which provides, for example, rdfs: subClassOf relation to define a class hierarchy. The knowledge graph uses, for example, RDFS and preferably OWL. With OWL, a distinction can be provided in owl: DatatypeProperty (attributes) and owl: ObjectProperty (relations).

SHACL provides a constraint language to validate the knowledge graph. SHACL is a supplement for a knowledge graph and can therefore be applied on an OWL knowledge graph.

The method can also be applied to graphs of graph data models other than that provided by the knowledge graph. The method is applicable to a memory in which triples of the knowledge graph are stored. The method is applicable to graph databases generally. The method is also applicable to other description languages and constraint languages.

The Resource Description Framework, RDF, used in the example is described in W3C Recommendation RDF 1.1 Concepts and Abstract Syntax of Feb. 25, 2014, which can be retrieved at https://www.w3.org/TR/rdf11-concepts/.

In the example, the knowledge graph comprises nodes representing entities and edges representing relations or attributes. In RDF, relations and attributes are referred to as “property” and, with respect to triples defining subject, predicate and object of a knowledge graph as “predicate”.

The knowledge graph is represented by a set of triples in the example. In the example, a triple comprises a subject, a predicate and an object. In the example, RDF triples are provided. An RDF triple in the example comprises a subject, for example an Internationalized Resource Identifier (IRI) of a node representing the subject. In the example, the RDF triple comprises an object, for example an Internationalized Resource Identifier (IRI) of a node representing the object or of a literal representing the object. The RDF triple comprises a predicate, for example a Internationalized Resource Identifier (IRI) of an edge representing the predicate.

The IRI is a Unicode string in the example. In the example, the Unicode string is formatted according to the syntax from RFC3987 of January 2005, which is retrievable at http://www.ietf.org/rfc/rfc3987.txt.

In the example, the literal comprises a lexical form and an IRI for a datatype. The lexical form is a Unicode string in the example. There are also literals without explicitly defined datatype, these being usable, for example, as a literal with the string type or with the integer type. Other cases are also possible.

The IRI for the datatype identifies the datatype that defines how the lexical form is mapped to a value for the literal.

The literal can also contain an identifier for a language. The identifier is designed, for example, as described in the IETF Best Current Practice “Tags for Identifying Languages” of September 2009, available at http://tools.ietf.org/html/bcp47.

Knowledge about a domain is stored in the knowledge graph. Nodes in the knowledge graph represent classes or instances in the example. Values of attributes are represented as literals in the knowledge graph. Properties as such, or SHACL NodeShapes and SHACL PropertyShapes, are themselves also represented by nodes in the knowledge graph, if the knowledge graph uses OWL. An instance is assigned to at least one direct class in the example. This means that there is at least one “instance-IRI rdf: type class-IRI” triple in the example. Superclasses can be defined for classes. This is defined, for example, by triples of form “class-IRI rdf: subClassOf class-IRI2”. SHACL constraints can be defined for classes or properties. Properties can be relations, for example object properties, or attributes, for example datatype properties. By means of SHACL, class-specific or property-specific constraints can be defined. In the example, these SHACL constraints are represented syntactically by multiple triples, and are assigned either to a SHACL NodeShape in the case of a class constraint or to a SHACL PropertyShape in the case of a property constraint per triple.

In the example, restrictions of properties are provided. These can be defined with OWL or with SHACL. In the context of this description, further restrictions are defined in addition to these restrictions. In the context of this description, these additional restrictions are referred to as property assertion constraint. The property assertion constraints can be included in the knowledge graph itself or can be stored outside the knowledge graph. For example, a restriction of a property defines a value range, and the additional restriction is a further restriction of this value range. The restriction is defined, for example, via SHACL or via OWL, and the property assertion constraint must be fulfilled in addition to this.

SHACL PropertyShapes are a possibility with which a definition of property assertion constraints can be represented, i.e., stored, in the knowledge graph. There are also other possibilities. For example, property assertion constraints can be defined or stored in an ontology or externally in a separate file.

In the example, a property assertion constraint is stored in the RDF graph.

In the knowledge graph, instances, for example things from the domain, are associated to nodes, which are connected to one another directly via a relation or indirectly via a chain of relations. A relation is represented in the knowledge graph by an edge between two nodes. The instances are often strongly interconnected, i.e., connected to one another with many relations. These connections describe knowledge and causalities in an explicit symbolic form. The instances can also be assigned attributes. Attributes are represented by literals in the example.

The method described below is also applicable to graphs other than knowledge graphs. The method described below is also applicable to other embeddings of the restrictions of properties.

The knowledge graph enables a logical inference, i.e., an automatic derivation of new knowledge by applying axioms and rules, which describe, for example, the laws in a specific domain. In the example, the knowledge graph represents the existing knowledge, e.g. facts and models that describe the real world. Examples of knowledge graphs are those relating to one of the domains of automobile, intelligent building, smart home.

Completeness, correctness and/or consistency of the knowledge provided by the knowledge graph is desirable for a correct logical inference.

The method described below makes it possible to check, prior to a change of an already existing knowledge graph, which are permissible characteristics of the knowledge described, and which are not. This means that, instead of checking an existing knowledge graph for completeness, correctness and consistency, the extensions are checked by means of property value assertions before the knowledge graph is extended. In the context of this description, the extension of the knowledge graph by an assignment of instances or literals via property for an instance is referred to as a property value assertion. As a result, semantically incorrect or false facts are avoided, instead of detecting and rectifying semantically incorrect or false facts in the knowledge graph.

Constraints, i.e., conditions, can be checked with OWL and/or SHACL. A condition can in particular be logical or mathematical. SHACL also makes it possible to form integrity constraints, i.e., constraints relating to an integrity of the knowledge graph, by means of SPARQL, for example; these are then queries, which are executed on the knowledge graph and can detect invalid facts. Both a simple constraint and a complex constraint can be checked with OWL and/or SHACL.

The simple constraint relates, for example, to a cardinality of relations or attributes. The simple constraint specifies, for example, whether a relation or an attribute is mandatory, i.e., at least one value is required, or not. The simple constraint specifies, for example, a limit for a maximum number of values of a relation or an attribute. The limit is, for example, a value or five values. The simple constraint can also predefine that no lower/upper limit exists, for example that any number of values are possible. The simple constraint specifies, for example, a permissible value range or permissible value ranges of relations. For example, the value range specifies instances of which class a relation is allowed to link. The simple constraint specifies, for example, which datatypes and/or values are possible for an attribute. Possible values can be, for example, integer values, in particular between 0 and 100. Possible values can be, for example, string values, in particular those that fulfill a predefined regular expression.

The complex constraint is formulated in the example by an integrity constraint, for example a SPARQL-based SHACL constraint. SPARQL refers to the SPARQL Protocol And RDF Query Language.

In the example, the property assertion constraint comprises a pattern for a query. The property assertion constraint can also comprise other components. Another component comprises, for example, a class-property pair, the instance to which the property assertion constraint applies, a description of the property assertion constraint in one language or multiple languages, and/or a path to a property assertion constraint, in particular dependent on the property assertion constraint, or multiple paths to other property assertion constraints, in particular dependent on the property assertion constraint. The pattern for the query is referred to below as query pattern. The query pattern can comprise simple and/or complex constraints.

The query pattern makes it possible to specify and validate relationships and conditions in the knowledge graph.

The property assertion constraint can be formulated in SPARQL syntax or, in the case of a graph database, with another graph-based query language. SPARQL is a query language for knowledge graphs that enables the formulation of simple and/or complex relationships and conditions. A query is a query that can relate, for example, to the knowledge graph and knowledge stored therein. In the example, SPARQL 1.1 is used according to the W3C recommendation of Mar. 21, 2013, which is available at https://www.w3.org/TR/sparql11-overview/.

The method generates SPARQL queries dynamically for a particular context of a given instance. In the example, query patterns of property assertion constraints, which represent query fragments, are embedded in a core query for the runtime. In the example, a query fragment or multiple query fragments are triggered in certain situations, i.e., executed together with the core query in a query.

The core query is able to ascertain all instances or literals that are permissible in principle for a given relation or a given attribute for a given instance without a query fragment. In the example, the core query uses a value range defined in the ontology for the relation or the attribute of the class for this purpose. The core query can be used generically and for all property assertion constraints. In the example, the core query is adapted by parameterization to the respective value range defined for a given instance-property pair. For example, the value range is defined by means of rdfs: range property in OWL or by SHACL constraint. rdfs: range is an example of a property according to RDF Schema 1.1 according to the W3C recommendation of 25 Feb. 2014, which can be retrieved at https://www.w3.org/TR/rdf-schema/.

The query fragment extends the core query by the additional conditions that the query fragment specifies in the form of at least one search pattern. A search pattern is referred to below as graph pattern. The resulting query can thus describe and check significantly more complex conditions and relationships.

By executing the query on the knowledge graph a result for extending the knowledge graph is determined. In the example, the result comprises either at least one permissible instance and/or at least one permissible literal for the extension of the knowledge graph or neither an instance nor a literal, if the query proceeds without a result, i.e., neither an instance nor a literal is found.

For example, an input variable is predefined that comprises an instance to be extended and a relation assigned to the instance to be extended and/or an attribute of the knowledge graph associated with this instance.

In the example, at least one property assertion constraint is determined with the input variable and is assigned to the input variable.

In the example, a predefined query fragment is determined for the property assertion constraint. The query fragment is embedded in the core query at a location provided for this purpose in the core query. The result of this embedding is referred to as query in the context of this description.

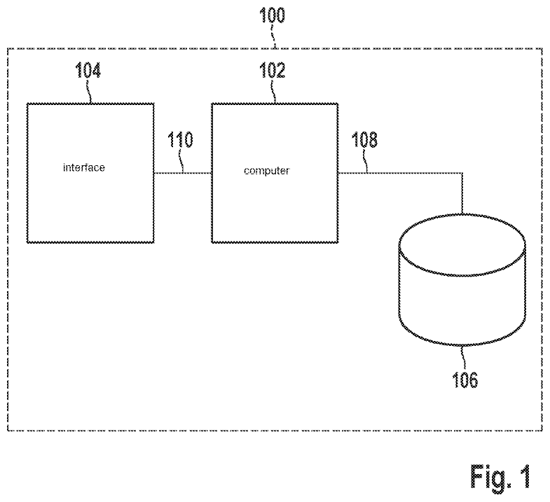

FIG. 1 shows a device 100.

The device 100 comprises a computing means 102, an interface 104 and a memory 106. In the example, the computing means 102 is connected to the memory 106 via a data line 108. The memory 106 can also be arranged outside the device 100. In the example, the computing means is connected to the interface 104 via a data line 110.

The device 100 is designed to manage and extend graphs, in particular knowledge graphs. In the example, the computing means 102 and the memory 106 comprise a graph database for the graph or, in particular for the knowledge graph, a memory for triples of the knowledge graph. The memory 106 is configured to provide the knowledge from the graph, in particular a knowledge graph or multiple knowledge graphs. This enables generic, self-adaptive, domain-independent applications, the complexity of which for creation, maintenance and adaptation can be significantly reduced, and which can be used in a much more versatile and flexible manner. The extension of graphs, in particular knowledge graphs is an essential process. This can be done by a human by means of a user interface, for example a browser-based front end, or by a machine. The interface 104 is designed to communicate with the user interface or the machine. In the example, the computing means 102 is designed to execute an application with which knowledge from the graph database, in the example from the memory for triples of the knowledge graph, can be retrieved, provided, extended, verified and/or changed via the interface 104. For example, the interface 104 is designed to program the application.

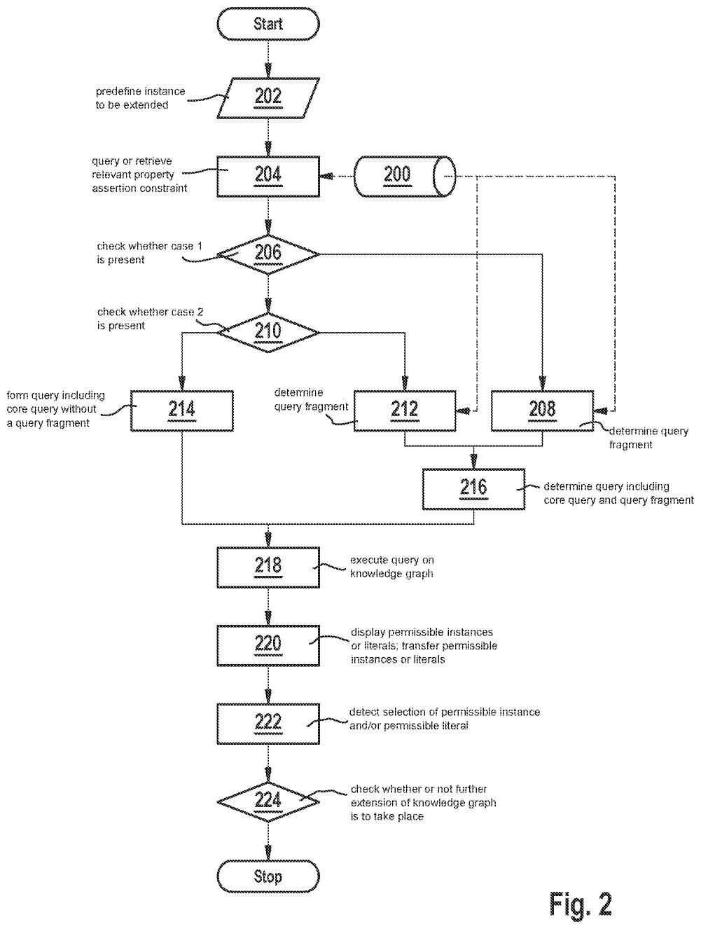

The method is described with reference to FIG. 2 using the example of a knowledge graph 200. The method is applicable to graph databases and specifically to a memory in which triples of the knowledge graph 200 are stored. In the example, the method starts when the knowledge graph 200 is to be extended, at an instance to be extended, to other instances by further relations of this instance or by at least one attribute value for this instance.

After the start of the method, a step 202 is executed.

In step 202, the instance to be extended is predefined. In addition, a relation or an attribute is predefined. For a class and, if present, a superclass or multiple superclasses of the instance, it is defined which relations or attributes are valid for the instance and can be used for property value assertions. For classes, it is defined which relations or attributes can be used for all instances of the class. In the example, this is done by rdfs: domain (definition range) in RDF/OWL, or by SHACL. In the example, in one class, the properties that are defined in the class itself or in one of their superclasses are valid. One class preferably inherits all the properties from all of the superclasses and can also add further properties.

Subsequently, a step 204 is executed.

In step 204, at least one relevant property assertion constraint is queried or retrieved. The query can take place in the knowledge graph 200 if the property assertion constraint is stored there. The property assertion constraint can be retrieved from another source on which property assertion constraints are stored. Preferably, multiple property assertion constraints are queried or retrieved.

For the respective instance to be extended and the respective relation and/or the respective attribute, it is checked in the example in the existing knowledge graph 200 whether relevant property assertion constraints exist.

If a relevant property assertion constraint exists, this is determined. Multiple relevant property assertion constraints can exist. A selection is made from these as follows. Otherwise, no property assertion constraint is determined. In the example, a distinction is made between multiple cases.

Case 1: An instance-specific property assertion constraint exists, i.e., a constraint that only applies to the given instance and relation or attribute.

Case 2: A property assertion constraint exists for a class of the instance, or one of its superclasses.

In the example, the property assertion constraints are defined at the level of SHACL Node Shapes and their contained SHACL Property Shapes in an ontology for the knowledge graph 200. In the example, the property assertion constraints are embedded in the knowledge graph 200. In the example, the property assertion constraints are readable and/or applicable from there. The property assertion constraints can also be stored elsewhere, at another location in the knowledge graph 200 or outside the knowledge graph 200.

Case 3: There is no relevant property assertion constraint. Other case definitions can also be used. For example, it is possible for only case 1, only case 2 or another case to be provided in addition to or instead of one of cases 1 to 3.

In a step 206, it is checked whether case 1 is present. If case 1 is present, a step 208 is executed. Otherwise, a step 210 is executed.

In step 208, a query fragment for the property assertion constraint is determined. In the example, a query fragment previously stored for this property assertion constraint is determined. In the example, the property assertion constraint is provided for the combination of instance AND property.

In step 210, it is checked whether case 2 is present. If case 2 is present, a step 212 is executed. Otherwise, a step 214 is executed.

In step 212, a query fragment for the property assertion constraint is determined. In the example, a query fragment previously stored for this property assertion constraint is determined. If multiple property assertion constraints exist for the class and its superclasses, provision can be made to select the property assertion constraint that, in a hierarchy defined for the class and its superclasses, is lowest in the hierarchy.

In the example, there is a maximum of one property assertion constraint for a particular property for a class. If superclasses exist, there can be multiple property assertion constraints. In one possible case, a property assertion constraint for the property is defined in each case either in the direct class of the instance itself and in one or more superclasses. In one possible case, a property assertion constraint is defined in the direct class of the instance, and not in a superclass. In a possible case, no such property assertion constraint is defined in the direct class, wherein one property assertion constraint is defined per superclass in one or more superclasses.

In the example, the following priority is implemented: If a property assertion constraint exists for the direct class of the instance, then this is selected. Only if this is not the case, that is to say no property assertion constraint is defined for the direct class and the property, and multiple property assertion constraints exist, then a property assertion constraint of the superclasses is selected, namely the property assertion constraint of the closest superclass, as described. Otherwise, for example, the one and only property assertion constraint of the one superclass for which a property assertion constraint is defined is selected.

An example of a property assertion constraint for finding compatible hardware for a device actuating or regulating the hardware is specified below. In this case, the property assertion constraint is defined as an extension of a SHACL Property Shapes in RDF:

```
sc:ControllingDevice
  a owl:Class;
a sh:NodeShape;
sh:property [
    a sh:PropertyShape;
    sh:path sc:hasHardware;
    sh:class sc:Hardware;
    sh:nodeKind sh:IRI ; sh:name “Hardware”;
    sh:minCount 1;
    sh:maxCount 1;
    pac: pattern “““BIND (%%instanceIRI%% as ?subject Instance).
        ?subjectInstance sc:belongsTo ?product Family.
        ?instance sc: releasedFor ?productFamily.”””;
    pac:comment “A product can only use hardware components
    released for the corresponding product family”@en;
pac:comment “Ein Produkt kann nur Hardwarebausteine verwenden,
die für die entsprechende Produktfamilie freigegeben
wurden”@de;
];
```

This means that sc: ControllingDevice is declared both as an OWL class and as a SHACL Node Shape. The SHACL property sh: property adds a SHACL Property Shape definition, which defines various constraints for the property sc: hasHardware of the class, to the SHACL Node Shape definition. In the example, the SHACL property sh: class is used to define the value range of the property. This constraint specifies, for all instances from the class sc: ControllingDevice, that only the instances of the class sc: Hardware or, implicitly defined, one of its subclasses are permissible as values for the property. In the example, a minimum cardinality (sh:minCount) and maximum cardinality (sh: maxCount) of 1 is also defined. This means that, for each instance from the class sc: ControllingDevice, exactly one relation sc:hasHardware must be defined with an instance from the class sc: Hardware.

For a predefined instance of the class sc: ControllingDevice, i.e., the subject, the property assertion constraint in the example can ascertain all permissible instances that are considered as the object of the relation sc:hasHardware with the subject. The permissible instances must be from the class sc: Hardware and fulfill the following condition: The hardware must be released for the same product family that is also assigned the device.

Subsequently, step 216 is executed.

In step 214, a query is formed which comprises the core query without a query fragment. In the example, this case occurs if neither case 1 nor case 2 is detected. In this case, the core query is only parameterized, that is to say adapted for a respectively defined value range.

An example of a core query is specified and described below:

In the example, a value range class is inserted. In line 06 of the core query: here % rangeClassIRI % is replaced by the IRI of the defined value range class. However, multiple value range classes can also be defined. Then, a correspondingly extended core query is used, which allows multiple classes to be inserted as parameters. For example, the logical component sh:or from SHACL is used for multiple classes. In this case, the property assertion constraint core query is supplemented by one or more UNION blocks with additional BIND expression. In the example, one such addition is carried out per additional value range class.

01 PREFIX rdfs: <http://www.w3.org/2000/01/rdf-schema#>
02 PREFIX owl: <http://www.w3.org/2002/07/owl#>
03 SELECT DISTINCT ?instance ?class ?label
04 WHERE {
05 # %%PACPatternPlaceholder%%
06 BIND (%%rangeClassIRI%% AS ?superClass).
07 ?superClass a owl:Class.
08 ?class rdfs:subClassOf* ? superClass.
09 ?instance a ?class.
10 OPTIONAL {?instance rdfs:label ?label.}
11 }

In line 05, a placeholder, PACPatternPlaceholder, is provided in the core query and in the example is replaced by the query fragment for the property assertion constraint when it exists, and otherwise is not replaced.

Subsequently, a step 218 is executed.

In step 216, a query that comprises the core query and the query fragment is determined.

In the example, the placeholder, PACPatternPlaceholder, is replaced by the query fragment for the property assertion constraint in line 05 of the core query. In addition, the IRI of the instance to be extended from the input variable is inserted into the query fragment at the location of the placeholder %% instance IRI %%.

An exemplary query of a property assertion constraint is reproduced below:

```
PREFIX rdfs: <http://www.w3.org/2000/01/rdf-schema#>
PREFIX owl: <http://www.w3.org/2002/07/owl#>
SELECT DISTINCT ?instance ?class ?label
WHERE {
        BIND (d:Room_Temp_Controller_A as ?subject Instance).
        ?subjectInstance sc:belongsTo ?productFamily.
        ?instance sc:releasedFor ?productFamily.
        BIND (sc:Hardware AS ?superClass).
        ?superClass a owl:Class.
        ?class rdfs:subClassOf* ? superClass.
        ?instance a ?class.
        OPTIONAL {?instance rdfs:label ?label.}
}
```

Subsequently, step 218 is executed.

In step 218, the query is executed on the knowledge graph 200. In the example, the result of the query comprises at least one permissible instance and/or at least one permissible literal, if one exists. Otherwise, the result of the query comprises neither a permissible instance nor a permissible literal.

In the example, the instances or literals permissible for the predefined instance are ascertained by means of the query. If the query also comprises the query fragment, this takes place taking into account the condition defined in the property assertion constraint or the conditions defined in the property assertion constraint.

It can also be provided to determine permissible literals for attributes with a query.

Property assertion constraints for attributes can determine a set of permissible literals. These can be determined, for example, as a set of strings (string datatype properties) or a set of numbers (integer attributes).

Attributes can determine valid or invalid intervals, in particular for numerical datatypes, e.g. natural numbers, real numbers, and date information, e.g. xsd: date, xsd: dateTime. Valid or invalid intervals for values X, Y are, for example: from X; to Y; greater than X; less than Y, or combinations thereof. Valid intervals specify, for example, a value range from which values may be selected. Values outside of the value range may not be selected. Invalid intervals specify, for example, a value range from which values may not be selected. Values outside of the value range may be selected.

A black list can also be provided, i.e., a value or a list of values of a datatype that may not be used, but all others may be used.

For strings, regular expressions can be generated, which allow an application to ascertain the valid or invalid strings itself.

Subsequently, a step 220 is executed.

In step 220, these permissible instances or literals can be displayed to a user via the interface 104 in the front end.

In step 220, the permissible instances or literals can be transferred via the interface 104 to a machine.

Subsequently, a step 222 is executed.

In step 222, a selection of at least one permissible instance and/or at least one permissible literal is detected.

It can be provided for the user to be able to select from the permissible instances or literals output via the interface 104 and displayed at the front end. An instance selected by the user at the front end or a literal selected by the user at the front end can be detected and/or used at the interface 104 or multiple instances or literals selected by the user can be detected and/or used at the interface 104.

It can be provided that instances or literals not selected by the user at the front end are not used.

It can be provided for the machine to be able to select from the permissible instances or literals transferred by the interface 104. It can be provided that an instance selected by the machine, in particular via the interface 104, or a literal selected by the machine, in particular via the interface 104, is detected and/or used. Provision can be made for multiple instances or literals selected by the machine, in particular via the interface 104, to be detected and/or used.

It can be provided that instances or literals not selected by the machine are not used.

The knowledge graph 200 is extended, for example, by a predefined relation to the selected instance or to selected instances. The knowledge graph 200 is, for example, extended by the literal as an attribute value for the predefined instance. It can also be provided that the knowledge graph 200 is extended by literals as attribute values for the predefined instance, in particular if multiple literals are permissible and/or selected.

In case 3, the core query is executed without any change, i.e., without a property assertion constraint, on the knowledge graph 200. The query ascertains the value range defined as standard of the relation or of the attribute. In the example, the knowledge graph 200 is also extended in case 3. However, in case 3, the method does not provide specific informed refinement and/or selection of values.

Subsequently, a step 224 is executed.

In step 224, it is checked whether or not a further extension of the knowledge graph 200 is to take place. For example, a query is sent to the user or the machine. If a response is detected, according to which a further extension is to take place, step 202 is executed. Otherwise, the method in the example ends.

In the example, the property assertion constraints are divided into instance-specific property assertion constraints, i.e., case 1, and class-specific property assertion constraints, i.e., case 2. A distinction can be made between the following two subtypes:

Instance-dependent property assertion constraints: These are property assertion constraints that include a given instance to be extended.

Instance-independent property assertion constraints: These are property assertion constraints that are independent of the instance to be extended and the environment thereof in the knowledge graph 200.

Instance-dependent property assertion constraints define, for example, conditions that the respective instance to be extended and/or instances connected to it must meet.

Property assertion constraints can predefine permissible or impermissible dependencies between relations that can be assigned to an instance to be extended. Property assertion constraints can predefine permissible or impermissible dependencies of attributes that can be assigned to an instance to be extended. Property assertion constraints can also comprise attributes of other instances that can be connected to the instance via one or more edges of the knowledge graph 200. Property assertion constraints can predefine permissible or impermissible dependencies between relations and attributes that can be assigned to an instance to be extended. It can be provided for these dependencies to be taken into account in a specific order. The order specifies, for example, the order in which the knowledge graph 200 is to be extended. In the example, this results in an order in which the found property assertion constraints are applied in the extensions of the knowledge graph 200. For example, it can be provided to use the property assertion constraints to define the relations and/or attributes that create the prerequisite for other relations and/or attributes first, so that the property assertion constraints thereof can be applied. For example, relations and/or attributes that occur and are used in other property assertion constraints are defined first. In the example, a resulting particular order or a process in which the knowledge graph 200 is extended is determined. In relation to the front end, this means that a certain sequence of user inputs is requested. In relation to the interface 104, this means that a certain sequence of inputs from the machine is requested.

In addition to avoiding inconsistent knowledge graphs, a property assertion constraint or multiple property assertion constraints can also be used to validate knowledge graphs. This is particularly relevant for cases in which the knowledge graph has been created or extended in a different way from that described above. This is particularly relevant for cases in which certain dependencies have been changed, which can cause an invalidation of property assertion constraints.

The method provides the following, for example, before step 202:

For an instance in the knowledge graph 200, iterate over its class-specific relations and attributes, and check whether the referenced instances or relations or the assigned literals or attributes per relation or attribute use only permissible values. In the example, permissible values are ascertained as valid by means of property assertion constraint if a property assertion constraint exists.

If a value other than the valid value or values other than the valid values are used, this is an inconsistency in the knowledge graph 200. In order to explain the inconsistency to a user in an understandable manner, it can be provided for a predefined explanation to be output. In the example, the specified predefined explanation of the property assertion constraint is output for which it was determined that a value other than a valid value or values other than the valid values is used. The predefined explanation is displayed, for example, in the front end. A further explanation component can additionally offer active links by means of which the user can navigate and/or jump directly to the locations in the knowledge graph 200 that cause the inconsistency, e.g. necessary dependencies and/or conditions at another location in the knowledge graph 200.

An essential advantage of the method is that the knowledge graph 200 is only extended by semantically correct facts. This is essential for all applications that consume knowledge and base their actions, decisions and operations thereon. Only in this way can they function correctly and without errors.

The described method virtually assumes the role of an expert who knows the knowledge graph, the domain and/or the applicable laws and/or constraints. The method automatically suggests only permissible instances and literals from which human or machine may or can select. Instead of an extension of the graph by new property value assertion and its subsequent validation, which can detect these facts as semantically incorrect only afterwards, or of the human expert, there is an informed, well-founded, automatic pre-ascertainment of suitable values and thus valid extensions of the knowledge graph, taking into account the applicable laws and/or constraints.

Application examples, in particular products, are described below. Many further applications are possible beyond this. The method can be used independently of application and domain.

A product is a device, for example. A system can comprise multiple products.

One application is to decisively support a configuration of new products, a construction of interoperable systems, and a definition of parameterization options of devices and systems. The support can be experienced by both a human and a machine, for example its software algorithm. For a person, the support can take place, for example, via the front end, in particular a suitable user interface. It can be provided for new products to be defined via the user interface, e.g. in a product portal. It can be provided for new systems to be generated via the user interface, e.g. in a system configurator. It can be provided for parameterizations of devices to be edited via the user interface, for example for a device configurator or commissioning tool.

Here, the property assertion constraints can provide critical help in only ever selecting the permissible components. A machine, in particular its software algorithm, can use the property assertion constraints that ascertain the permissible instances or literals for a given instance and relation or attribute, via the interface 104, and thus automatically perform tasks such as a configuration of new products, a generation of interoperable systems, a parameterization of devices.

Property assertion constraints can be used for a configuration of new products. In this example, conditions for the configuration of a product from various components are specified by means of a property assertion constraint. Components are, for example, components of devices of a residential heating system, in particular its hardware, firmware and/or software. A property assertion constraint defines, for example, that only components that are developed for one another, in compatible versions, can be selected and combined to form a new product. This makes it possible for the new product to be designed in an automated manner by means of a machine or by a non-expert with correct functioning of the new product, or for an expert to be supported significantly in the process. This saves time and effort and ensures or improves the consistency and quality of the data provided.

Property assertion constraints can be used for a composition of interoperable systems. Interoperable systems are, for example, residential heating systems. In this example, compatibility criteria for parts of an interoperable system are specified by means of property assertion constraints. For example, criteria are defined that, step by step, suggest for a growing system only those devices that are compatible in pairs with all other devices already selected. This enables a simple, computer-aided creation of systems for which it is ensured that after their installation, e.g. in a building, a factory or in the Internet of Things (IOT), i.e., a distributed communication infrastructure for devices, they function without errors and all devices are interoperable with one another.

An exemplary property assertion constraint can specify, for example, that products within the system must be from the same manufacturer or the same brand. An exemplary property assertion constraint can specify, for example, that the products within the system have been released for the same target markets. An exemplary property assertion constraint can specify, for example, that the products within the system use communication tokens exclusively, i.e., without overlapping. An exemplary property assertion constraint can specify, for example, that the products within the system form device communication pairs that must fulfill interoperability criteria in pairs within the system. Interoperability criteria are, for example, technical, syntactic, semantic, conceptual interoperability.

Further complex conditions can be specified within the property assertion constraint or in separate property assertion constraints or rules for this.

It can be provided for property assertion constraints to be combined with reasoning, e.g. rules, but also OWL reasoning. In the example, reasoning refers to description logics. For this purpose, property assertion constraints are applied to a knowledge graph 200, which is extended, i.e., enriched by a reasoner. In the example, this extended knowledge graph 200 receives logical consequences, and property assertion constraints can use these. This makes it possible to simplify some property assertion constraints. On the other hand, extended use cases can also be realized, which otherwise can be formalized only in a very complicated manner or not at all.

It can be provided for property assertion constraints to be used for a parameterization of products or systems.

It can be provided for property assertion constraints to be used for a parameterization of products or systems. A parameterization is carried out, for example, by hardware-side parameters, in particular jumpers or rotary switches. A parameterization is carried out, for example, by software-side parameters, in particular software parameters, setting by menu in a device display and/or firmware upload. It can be provided for the parameterization to be designed such that a functionality and/or a behavior of a product and/or a system comprising multiple products is changed as a whole.

Property assertion constraints can be used in a definition of possible parameterizations of products or systems. For example, property assertion constraints are provided that ensure that only communication tokens or functions that are supported on the hardware and software side by the devices or the system as a whole can be active.

For example, property assertion constraints are provided that specify dependencies and causalities between the various parameters and their values. For example, property assertion constraints are provided that predefine, in particular depending on already selected parameter values, how further parameters can be used and set, i.e., which values are permissible for these parameters. This supports a process of parameterizing products or systems. This supports commissioning of devices and systems. This achieves consistent, valid parameterizations, for example in the context of a commissioning tool.

1-11. (canceled)

12. A computer-implemented method for extending a knowledge graph, comprising the following steps:
predefining an input variable including an instance to be extended and a relation associated with the instance to be extended and/or an attribute of the knowledge graph related to the instance to be extended;
determining a first property assertion constraint associated with the input variable;
determining a query fragment for the first property assertion constraint;
determining a query including a predefined core query and the query fragment; and
executing the query on the knowledge graph, a first result being determined that includes either: (i) at least one permissible instance and/or at least one permissible literal for extending the knowledge graph, or (ii) no instance and no literal.

13. The method according to claim 12, further comprising displaying the first result displayed to a user or outputting the first result to a machine.

14. The method according to claim 13, wherein a second property assertion constraint is determined, a second result being determined for the second property assertion constraint that either includes: (i) at least one permissible instance and/or at least one permissible literal for extending the knowledge graph, or (ii) no instance and no literal, a sequence of inputs of the user or inputs from the machine being requested depending on the first result and the second result, and the knowledge graph is extended depending on the sequence, the sequence defining an order for queries of the inputs in which a first query is made according to the first result before a second query is made according to the second result, the second result or the second query being determined depending on an input in response to the first query.

15. The method according to claim 12, wherein a selection of at least one permissible instance for extending the knowledge graph is detected, and the knowledge graph is extended by a predefined relation of the instance to be extended to the at least one permissible instance, and/or a selection of at least one permissible literal for extending the knowledge graph is detected, and the knowledge graph is extended by an attribute for the instance to be extended.

16. The method according to claim 12, wherein the determining of the first property assertion constraint includes:
determining the first property assertion constraint associated with the instance to be extended or associated with a class associated with the instance to be extended.

17. The method according to claim 12, wherein the instance to be extended is associated with a first class, and the determining of the first property assertion constraint includes:
determining the first property assertion constraint associated with a second class that is closest to the first class in a class hierarchy.

18. The method according to claim 16, wherein the determining of the first property assertion constraint includes finding a constraint of the graph that applies to the instance.

19. The method according to claim 12, wherein when it is detected that no relevant property assertion constraint exists, the query is determined without a query fragment.

20. The method according to claim 12, wherein the input variable is read from a graph database in which the knowledge graph is stored including a memory for triples of the knowledge graph, the query being executed on the graph database.

21. A device for extending a knowledge graph, the device configured to:
predefine an input variable including an instance to be extended and a relation associated with the instance to be extended and/or an attribute of the knowledge graph related to the instance to be extended;
determine a first property assertion constraint associated with the input variable;
determine a query fragment for the first property assertion constraint;
determine a query including a predefined core query and the query fragment; and
execute the query on the knowledge graph, a first result being determined that includes either: (i) at least one permissible instance and/or at least one permissible literal for extending the knowledge graph, or (ii) no instance and no literal.

22. A non-transitory computer-readable medium on which is stored a computer program including computer-readable instructions for extending a knowledge graph, the instructions, when executed by a computer, causing the computer to perform the following steps:
predefining an input variable including an instance to be extended and a relation associated with the instance to be extended and/or an attribute of the knowledge graph related to the instance to be extended;
determining a first property assertion constraint associated with the input variable;
determining a query fragment for the first property assertion constraint;
determining a query including a predefined core query and the query fragment; and
executing the query on the knowledge graph, a first result being determined that includes either: (i) at least one permissible instance and/or at least one permissible literal for extending the knowledge graph, or (ii) no instance and no literal.
